(19) United States
(12) Patent Application Publication
(10) Pub. No.: US 2005/0154516 A1
(43) Pub. Date: Jul. 14, 2005

(54) Method and a system for processing measurement signals for characterizing the state of occupancy of a motor vehicle seat

(75) Inventors: Herve Dirand, Valentigney (FR); Yann Rogard, Valentigney (FR); Laurent Chabert, Cerny (FR); Bertrand Billon, Palaiseau (FR); Frederic Fays, Noisy Le Grand (FR); Eric Rochat, Bruyeres Le Chatel (FR)

Correspondence Address: MARSHALL, GERSTEIN & BORUN LLP, 233 S. WACKER DRIVE, SUITE 6300, SEARS TOWER, CHICAGO, IL, 60606, US

(73) Assignee: FAURECIA, Nanterre (FR)

(21) Appl. No.: 11/009,719

(22) Filed: Dec. 10, 2004

(30) Foreign Application Priority Data
Dec. 15, 2003 (FR) FR03 14692

(51) Int. Cl. G06F 17/00; B60R 21/32

(52) U.S. Cl. 701/45; 280/735; 180/273

(57) ABSTRACT

A method of processing measurement signals output from a detection array comprising at least one sensor, for characterizing the state of occupancy of a motor vehicle seat. The method includes a classification operation for classifying the state of occupancy of the seat. The method also includes a correction operation, during which the measurement signal output by the detection array is corrected at least in part for environmental drift relating to temperature and to humidity prior to being analyzed in the classification operation for classifying the state of occupancy.

The present invention relates to methods and systems for processing measurement signals from a detection array made up of at least one sensor, for characterizing the state of occupancy of a motor vehicle seat.

More particularly, the invention relates to a method of processing measurement signals output from a detection array comprising at least one sensor, for characterizing the state of occupancy of a motor vehicle seat. The method includes a classification operation for classifying the state of occupancy of the seat, during which analysis of a measurement signal output by each sensor of the detection array delivers a first item of information about the occupancy, which item is classified in a first class if the seat is empty or occupied by a child restraint device, and classified in a second class if the seat is occupied by an adult.

### BACKGROUND OF THE INVENTION

The document “BioVolume: The seat integrated human based system to meet FMBSS208 Automatic Suppression concerns”, by Marc Pajon et al. (Society of Automotive Engineers Word Congress 2003, SAE 03B-235) describes such a method.

That type of method was developed to deliver information about the morphological class and about the dynamic position of an occupant of a motor vehicle seat to the passive safety system of the vehicle including the seat, so as to increase protection of said occupant. That type of information is, in particular, taken into account in the decision to deploy an airbag, in the event of a front impact, in order to reduce the risks of injury caused by such an airbag in young children and small adults.

### OBJECTS AND SUMMARY OF THE INVENTION

The method indicated above is entirely satisfactory. However, a particular object of the present invention is to improve it.

To this end, the invention provides a method of processing measurement signals output from a detection array, for characterizing the state of occupancy of a motor vehicle seat, which method, in addition to the above-mentioned characteristics, further includes a correction operation, during which the measurement signal output by each sensor of the detection array is corrected at least in part for environmental drift relating to temperature and to humidity prior to being analyzed in the classification operation for classifying the state of occupancy, the measurement signal form each sensor being corrected by using a combination of prior measurements output by said sensor.

By taking account of-environmental drift relating to temperature and to humidity, it is possible to make the classification operation for classifying the state of occupancy of the seat more reliable and thus to increase further the safety of the occupants of a motor vehicle.

In preferred embodiments of the invention, it is optionally possible also to use one or more of the following provisions:
the correction operation also takes account of any interference generated by contact between the passenger and the bodywork of the vehicle;
the correction operation also takes account of any interference generated by the presence of a wet obstacle;
the method also includes a classification operation for classifying the position of the occupant in the seat, during which analysis of the signal output from the correction operation delivers information about the position of an occupant in the seat; optionally, information about the distance between the occupant and at least one sensor is also delivered in this operation;
the classification operation for classifying the position of the occupant in the seat incorporates an occupancy reliability factor;
the method also includes another classification operation for classifying the position of the occupant in the seat, during which account is taken both of information about the position of the occupant in the vehicle and also of information resulting from a statistical model of the morphology and of the movements of the occupant of the seat;
the correction operation compensates for the temperature drift on the basis of calculating one tracer per sensor;
the correction operation detects a wet obstacle by implementing a detection plane method;
for each sensor, the correction operation compensates for temperature drift on the basis of calculating a local temperature and humidity tracer; and
for each sensor, the correction operation compensates for temperature drift on the basis of using combinations of measurements that are insensitive to environmental conditions and that are output by the corresponding sensor.

In another aspect, the invention provides software for implementing the above-mentioned method, which software is designed to be loaded into an on-board micro-controller.

In yet another aspect, the invention provides a central processing unit programmed for implementing the method indicated above.

In yet another aspect, the invention provides a motor vehicle seat including such a central processing unit.

In yet another aspect, the invention provides a system for processing measurement signals, for characterizing the state of occupancy of a motor vehicle seat, said system comprising a detection array integrated in the seat and itself comprising at least one sensor, and a central processing and detection unit programmed for implementing the method indicated above.

Other aspects, objects, and advantages of the invention will appear on reading the description of one of its embodiments.

### BRIEF DESCRIPTION OF THE DRAWINGS

The invention will also be better understood with the help of the drawings, in which:

FIG. 1 is a diagram showing a system of the invention for processing measurement signals, the system comprising a central processing unit and a seat provided with an array of capacitive measurement sensors;

FIG. 2 is a flow chart of an example of an implementation of the method of the invention; and

FIG. 3 is a graph showing the detection and non-detection areas for a wet obstacle.

### MORE DETAILED DESCRIPTION

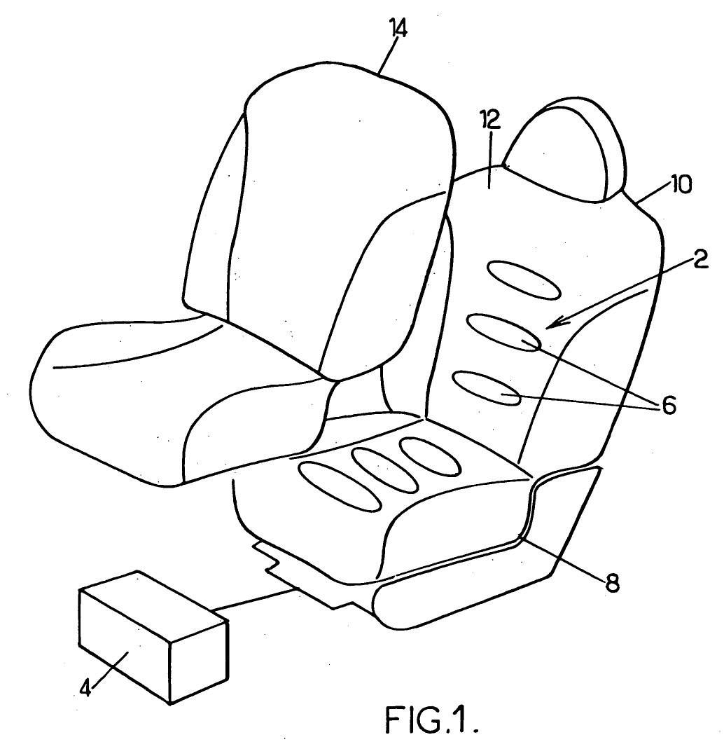

As shown in FIG. 1, the system of the invention for processing measurement signals comprises a detection array 2 and a central processing unit 4. The detection array 2 is made up of a plurality of sensors 6 disposed in a seat proper 8 and in a seat back 10 of a motor vehicle seat. The detection array 2 is placed between the padding 12 and the cover 14 of the seat. Each sensor 6 is provided with at least two electrodes and the measured signal corresponds to a measurement of the capacitance of each sensor 6. Detection arrays of this type are described in the document “Distance corrected capacitive sensors for advanced air bag applications”, by Jérôme Lucas et al. (S.A.E. 03B-18).

The central processing unit 4 is generally integrated in a motor vehicle seat. Said central processing unit 4 is programmed for implementing the method of the invention.

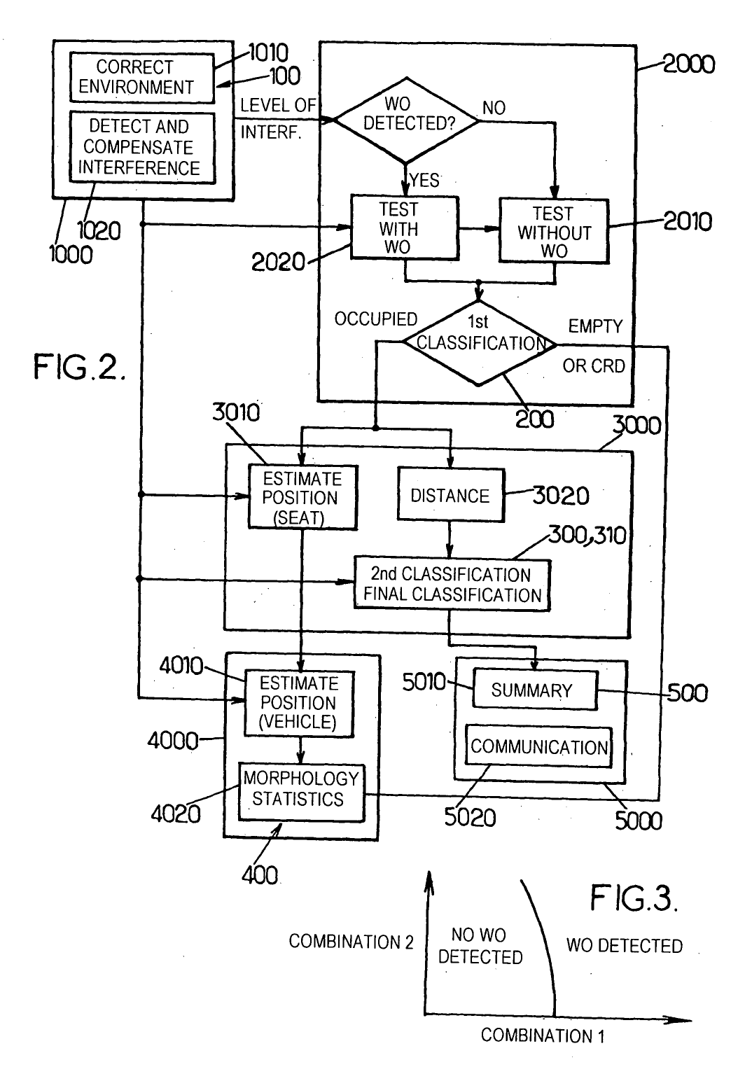

As shown in FIG. 2, the example of the method of the invention described herein processes measurements from each sensor 6 in five main operations 100, 200, 300, 400, and 500.

In the first of the operations (100), implemented by a first functional unit 1000, the signals generated by each sensor 6 are digitized and conditioned to deliver information that is insensitive:
to environmental drift such as temperature drift and humidity drift;
to interference generated by contact of the passenger with the bodywork of the vehicle; and
to interference generated by the presence of a wet obstacle (wet towel, damp seat, etc.).

Environmental drift is compensated by implementing four calculations, performed by a module 1010.

In the first calculation, a temperature and humidity tracer is determined for each sensor C. For each sensor C, the tracer can be expressed by the following relationship:
T_{c}=P_{l,c}−aP_{m,c}

Where P_{l,c} and P_{m,c} correspond to measurements generated by the sensor C at distinct moments, and then digitized.

The coefficient a is the gradient, averaged over a defined temperature and humidity range, of the linear relationship between the measurements P_{l,c} and P_{m,c} when the geometric characteristics and the position of a conductive surface on the seat equipped with system of the present invention are caused to vary under predefined conditions.

Then, a second calculation is performed for calculating data compensated for offset drift. A new value of the measurement is thus obtained that is given by:
P_{i,c comp offset}=P_{i,c}+α_{i,c}·T_{c}+β_{i,c}

The coefficients α_{i,c} and β_{i,c} are respectively the gradient and the ordinate intercept of the linear relationship between P_{i,c} and T_{c} when the seat, equipped with the system of the invention, and not occupied, is subjected to a predefined temperature and humidity cycle.

A third calculation for calculating data compensated for offset drift is performed by a new value of the measurement given by:
D_{lm,c.comp.offset}=P_{l,c}−γ_{lm,c}P_{m,c}−δ_{lm,c}

The coefficients γ_{lm,c} and δ_{lm,c} are repsectively the gradient and the ordinate intercept of the linear relationship between P_{l,c} and P_{lm,c} when the seat, equipped with the occupant classification system and not occupied, is subjected to a predefined temperature and humidity cycle.

In a fourth calculation, the offset drift compensated measurements described above are used to define offset and gain drift compensated measurements. A measurement that is fully compensated for environmental drift is thus obtained, given by:

$${X}_{i , c . comp . Gain} = \frac{{X}_{i , c . comp . offset}}{1 + {A}_{i , c} \cdot {T}_{c} + {B}_{i , c} \cdot {X}_{i , c . com . offset} + {C}_{i , c} \cdot f ( 〈 {P}_{i , c} 〉 )}$$

where A_{i,c}, B_{i,c}, and C_{i,c} are coefficients determined after optimization on one or more conductive targets of specific geometrical shapes and positions, the optimization being based on a criterion for minimizing gain drift for said specific targets, and f(<P_{i,c}>) is any function of a measurement generated by the sensor C.

The resulting corrected measurements are then subjected to compensation, performed by a module 1020, and serving to take account of whether or not the occupant of the seat is in electrical contact with the bodywork. The interference generated by contact between the passenger and the bodywork of the vehicle is detected via the electrical potential of the individual that is itself determined by means of two specific stages referred to as “UC” and “UC_{g}”, where UC and UC_{g} designate different measurements corresponding to respective ones of two measurement stages during which certain electrodes of the sensor are biased. If the difference UC−UC_{g} is less than a threshold value determined by analyzing a database, then it is deduced that the individual is at a fixed potential. The individual is then in contact with the bodywork of the vehicle. Otherwise, the individual is at a floating potential.

The first functional unit 1000 delivers not only measurements that are corrected and compensated for the various kinds of interference, but it also delivers a level of interference.

In particular, the first functional unit 1000 delivers information about the level of the interference detected: extreme temperature or humidity, presence of a wet obstacle (WO in FIG. 2), etc.

The measurements corrected by the preceding calculations then serve to detect wet obstacles by means of a method referred to as the “detection plane” method and that is well known to the person skilled in the art. As shown in FIG. 3, it is possible, by appropriately choosing linear combinations of the corrected measurements, using that method, to separate the plane into two zones, namely one zone corresponding only to situations without a wet obstacle being detected and another zone corresponding only to situations in which a wet obstacle is detected. The level of interference is deduced therefrom.

The level of interference indicates in particular whether or not a wet obstacle has been detected. This information about the detection of a wet obstacle is transmitted to a second functional unit 2000.

The corrected measurements are also transmitted to the second functional unit 2000 for undergoing a second operation 200 making it possible to perform a first classification of the state of occupancy of the seat. Said first classification corresponds to a first item of information about the occupancy of the seat that is classified in a first class if the seat is empty or occupied by a child restraint device (CRD in FIG. 2), and classified in a second class if the seat is occupied by an adult. An individual of morphology greater than or equal to the morphology of a 5^{th} percentile woman is considered to be an adult. Implementation of that classification of the state of occupancy is described in the above-mentioned document by Marc Pajon et al.

The first classification 200 incorporates whether or not a wet obstacle has been detected at the first functional unit 1000. When no wet obstacle has been detected, the test, performed by a module 2010, making it possible to distinguish between the first and the second classes is as follows:

If

$${\sum }_{i} {\sum }_{c} ( {ρ}_{i , c} \cdot {ρ}_{i , c} ) > A ,$$

where ρ_{i,c} and A are constant, then the information is classified in the first class. Otherwise, the information is classified in the second class.

The coefficients ρ_{i,c} are determined by analyzing a database for a plurality of an individuals, a plurality of CRDs, a plurality of wet obstacles, a plurality of dry obstacles, etc. Once the analysis is finished, these parameters are constants.

When a wet obstacle is detected, the test performed by a module 2020 is identical, except the coefficients ρ_{i,c} are replaced by other constants ρ_{i,c}.

If, in the preceding step, an individual has been detected as being an occupant of the seat, an estimate of the position of the occupant in the seat is generated at a module 3010. Said estimate is generated by taking account of the measurement performed by each sensor and corrected in the first operation 100. The method of implementing said estimate is described in the above-mentioned document by Marc Pajon et al.

Said estimate of the position of the occupant in the seat and the information indicating that the seat is occupied, generated by the functional unit 2000, then serve to correct the measurements once again so as to take account of the distance between the occupant and the sensor 6 from which the measurement is output and to perform the corresponding compensation on the measurements at a distance correction module 3020 prior to deducing therefrom the information about the morphology of the occupant.

The distance correction module 3020 needs to have information about the position of the occupant in the seat. This information is delivered by the module 3010. The distance correction algorithm is identical regardless of position, but the parameters of the algorithm are functions of the position of the occupant in the seat. These parameters are set by analyzing an experimental database.

On the basis of this information, the method of the invention establishes a second classification 300 in which the first class corresponds to the situation in which the seat is empty or occupied by a child restraint device, or else occupied by a child of in the range three years to six years, and a second class corresponding to the situation in which the seat is occupied by an adult of morphology greater than or equal to the morphology of a 5^{th} percentile woman. That classification is described in the above-mentioned document by Marc Pajon et al.

In addition, said second classification 300, which is an instantaneous classification, is weighted by information about the reliability of said classification. Said information about the reliability of said classification is itself a function of the position of the occupant on the seat. By analyzing the experimental databases, it can be observed that the error rate (corresponding to erroneous classifications) is larger in certain positions than in others. For such positions, the confidence index is then lower. For example, if the passenger is seated on the front edge of the seat, the reliability of the information of the second classification is lower than the reliability obtained with the same individual but properly seated back in the seat, which corresponds to the situation in which a higher number of sensors 6 are operational.

A final classification 310 is then delivered as a function of the first classification 200 and of the instantaneous second classification 300 weighted by the reliability information.

Said final classification 310 corresponds to classifying the morphology of the occupant of the seat.

In an optional fourth operation 400 implemented by a fourth functional unit 4000, a new classification of the position of the occupant of the seat relative to the reference frame of the vehicle is established on the basis of:
the estimate performed by the module 3010 of the position of the occupant in the seat, resulting from the final classification output by the third functional unit;
information about the position of the seat (position of the seat on the runners, position of the seat back relative to the seat proper, etc.) delivered by external sensors at a module 4010; and
a statistical study about the morphology and the movements of the occupant that is incorporated in a module 4020.

Classifying the position of the occupant of the seat relative to the vehicle is described in the above-mentioned document by Marc Pajon et al.

In a fifth operation 500 implemented by a fifth operational unit, the information is summarized. This summary, performed by a module 5010, takes account of the classification of the position of the occupant in the seat that is output from the fourth operation 400, of the morphological classification output from the final classification 310, and optionally of the information output by the second operation 200 indicating that the seat is empty or occupied by a child restraint device.

Said summary is communicated by a module 5020 to a decision management system of the vehicle in order to trigger an airbag device, for example.

1. A method of processing measurement signals output from a detection array comprising at least one sensor, for characterizing the state of occupancy of a motor vehicle seat, said method including a classification operation for classifying the state of occupancy of the seat, during which analysis of a measurement signal output by each sensor of the detection array delivers a first item of information about the occupancy, which item is classified in a first class if the seat is empty or occupied by a child restraint device, and classified in a second class if the seat is occupied by an adult;
said method further including a correction operation, during which the measurement signal output by each sensor of the detection array is corrected at least in part for environmental drift relating to temperature and to humidity prior to being analyzed in the classification operation for classifying the state of occupancy, the measurement signal form each sensor being corrected by using a combination of prior measurements output by said sensor.

2. A method according to claim 1, in which the correction operation also takes account of any interference generated by contact between the passenger and the bodywork of the vehicle.

3. A method according to claim 1, in which the correction operation also takes account of any interference generated by the presence of a wet obstacle.

4. A method according to claim 1, also including a classification operation for classifying the position of the occupant in the seat, during which analysis of the signal output from the correction operation delivers information about the position of an occupant in the seat.

5. A method according to claim 4, in which the classification operation for classifying the position of the occupant in the seat also delivers information about the distance between the occupant and at least one sensor.

6. A method according to claim 4, in which the classification operation for classifying the position of the occupant in the seat incorporates an occupancy reliability factor.

7. A method according to claim 4, including another classification operation for classifying the position of the occupant in the seat, during which account is taken both of information about the position of the occupant in the vehicle and also of information resulting from a statistical model.

8. A method according to claim 1, in which the correction operation compensates for the temperature drift on the basis of calculating one tracer per sensor.

9. A method according to claim 1, in which the correction operation detects a wet obstacle by implementing a detection plane method.

10. A method according to claim 1, in which, for each sensor, the correction operation compensates for temperature drift on the basis of calculating a local temperature and humidity tracer.

11. A method according to claim 1, in which, for each sensor, the correction operation compensates for temperature drift on the basis of using combinations of measurements that are insensitive to environmental conditions and that are output by the corresponding sensor.

12. A central processing unit programmed for implementing the method according to claim 1.

13. A system for processing measurement signals, for characterizing the state of occupancy of a motor vehicle seat, said system comprising a central processing unit according to claim 12, and a detection array integrated in the seat and itself comprising at least one sensor.

14. A motor vehicle seat including a central processing unit according to claim 12.
